(19) United States
(12) Patent Application Publication
(10) Pub. No.: US 2003/0112618 A1
(43) Pub. Date: Jun. 19, 2003

(54) Device and method for illuminating input keys

(76) Inventor: Mary Ann Bryant, Richmond, TX (US)

Correspondence Address: R. PERRY MCCONNELL, P.C., 9001 FOREST CROSSING, SUITE F, THE WOODLANDS, TX, 77381, US

(21) Appl. No.: 10/022,685

(22) Filed: Dec. 17, 2001

(51) Int. Cl. G01D 11/28; F21V 8/00

(52) U.S. Cl. 362/26; 362/23; 362/551; 362/559; 200/314

(57) ABSTRACT

The invention provides a device and method for illuminating keypad-type input devices, utilizing a light source, such as an LED, and transmitting the output of the light source to individual input loci via a fiber optic light guide.

### FIELD OF THE INVENTION

The invention provides a device and method for illuminating keypad-type input devices.

### BACKGROUND OF THE INVENTION

Standard computer keyboards are not self-illuminating, and thus require an ambient light source for the user to read the notations on the key caps. Many such keyboards provide one or more light emitting diode (“LED”) indicators. For example, LEDs may be used to show the user whether the “Num Lock” or “Caps Lock” keys are turned “on.” However, the input keys themselves are not generally lighted so that they may be easily read under low-light or no-light conditions.

However, many computer users find themselves with a need to utilize their computers in conditions of low ambient light. For example, a computer user who is operating a computer at night in the same room as, say, a sleeping spouse, may find it desirable to operate the computer with the room lights turned off. However, the glow from the computer screen is rarely sufficient to illuminate the keyboard, and further degrades the user's ability to see the keyboard by inhibiting night vision.

Although these conditions may not be prohibitive for the true touch-typist, a great many computer users must still rely on looking at the keys while typing. Further, lesser-used keys around the periphery of the keyboard must often be looked for even by the accomplished typist. Accordingly it is desirable to provide unobtrusive illumination of the keyboard which will neither disrupt the computer user's ability to operate the computer, nor disturb those in the surrounding environment. However, it is also desirable that such illumination come from a source which is not obtrusive, bulky, nor prohibitively expensive. It is also desirable that providing such illumination not produce a substantial additional power load for the computer, both for general goals of power conservation and to allow portable computers to readily supply the necessary power.

It is an object of the invention to provide illumination for computer keyboards and keypads for use under low- and no-ambient light conditions.

It is a further object of the invention to provide illumination for computer keyboards and keypads which provides ease of manufacture and integration with currently available equipment.

It is a further object of the invention to provide illumination for computer keyboards and keypads which is economical in equipment and power usage.

### SUMMARY OF THE INVENTION

The invention comprises a light source, such as a light emitting diode (“LED”), which may be illuminated by providing electrical power to the light source. In the preferred embodiment of the invention, the light source is a “super bright” LED. The light source is optically coupled to the inlet of a fiber optic light guide. The fiber optic light guide preferably comprises a plurality of fiber optic strands, each with an inlet and an outlet, optically coupled to the light source so that the inlet of each strand receives light from the source and the light is readily transmitted by the strand. In the preferred embodiment, the outlet of each strand of the light guide is optically coupled to an input locus, such as a computer key, in such a way that the light illuminates the top of the key.

Those of skill in the art will understand that the optical coupling of the outlet to the input locus may be accomplished in a variety of ways. These include, without limitation, providing translucent keys, so that the entire key is effectively lighted and the label on the key top is visible or using di-injected plastic to provide a translucent key label which may be illuminated from below. Other means of optically coupling the outlet to each input locus may be used without departing from the spirit of the invention.

The ease of routing fiber optic light guides to deliver light from the light source to the individual input loci provides great flexibility in positioning the light source, and is integrable into the normal design of keyboards and keypads without the need for substantial layout alterations. Further, the flexibility of fiber optics allows the individual strand outlets to be directly coupled to, or positioned directly under or near, each input locus without altering the user's feel of the keyboard or keypad.

Moreover, the preferred use of LEDs provides an economical light source which will not add a substantial power drain to the computer, thus promoting conservation and making the light source readily useable with battery powered devices, such as portable computers.

Additionally, it is preferred to provide an in-circuit control, such as a potentiometer, to allow the user to control the voltage supply to, and thus the intensity of, the light output from the light source.

Further variations of this device are possible, such as providing varying colors of LEDS which are switch-selectable to allow the user to choose the color of the key illumination.

### BRIEF DESCRIPTION OF THE DRAWINGS

FIG. 1A is a schematic diagram of the light generation and light guide portion of the input device illumination apparatus.

FIG. 1B is a schematic diagram of one embodiment of the connection of the light guide to an input key.

FIG. 2 is a schematic diagram of an alternate embodiment of the light generation portion of the input device illumination apparatus.

### DETAILED DESCRIPTION OF THE PREFERRED EMBODIMENT

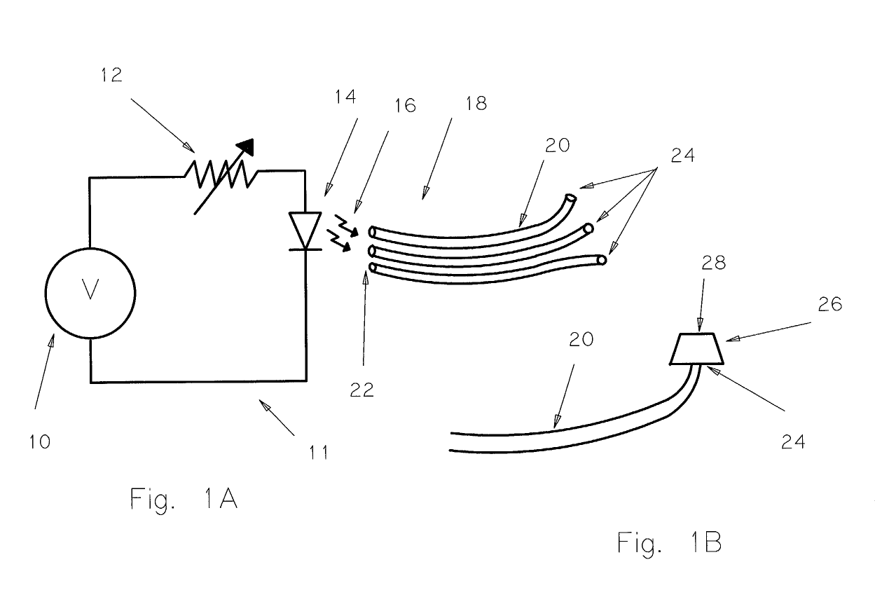

Referring to FIGS. 1A and 1B, a one embodiment of the device is schematically depicted. A power source, such as a voltage source 10 is electrically coupled to a control device, such as a potentiometer 12. The potentiometer 12 is in turn electrically coupled to an LED 14, which is also electrically coupled to the voltage source 10 to complete the circuit 11. When current flows through the circuit 11, the LED 14 emits light 16, the intensity of which is regulated by the setting of potentiometer 12. The LED 14 is optically coupled to the inlet 22 of a fiber optic light guide 18. In the preferred embodiment, the fiber optic light guide 18 comprises multiple fiber optic strands 20, each of which terminates in an outlet 24.

The outlet 24 of each fiber optic strand 20 optically coupled to an input locus, such as a computer key 26. The top 28 of the computer key 26 is constructed so that transmitted light 16 from the LED 14 illuminates the label (not shown) on the top of the computer key 26. Such illumination may be effected by a variety of means, such as making the entire computer key 26 translucent, making the label translucent and the remainder of the computer key 26 opaque, or making the label opaque and the remainder of the computer key 26 translucent. Such variations will be understood by those of skill in the art to be matters of choice which do not depart from the invention.

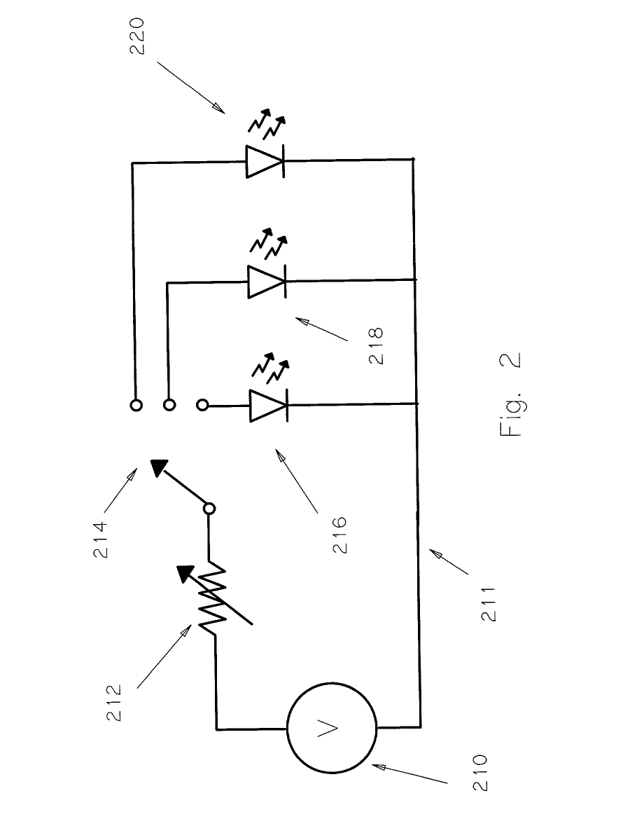

Referring to FIG. 2, an alternative embodiment of the light generation portion of the of the input device illumination apparatus is shown schematically. In this embodiment, a circuit 211 comprises a power source 210 which is electrically coupled to a control device such as potentiometer 212. Potentiometer 212 is further electrically coupled to a selector switch 214, which may be selectively positioned by the user to direct illumination of LEDs 216, 218, or 220. By incorporating LEDs of varying color output in positions 216, 218, and 220, the user may be allowed to choose the color of illumination which is provided through the device.

I claim:

1. A device for illuminating an input device, comprising
a light source,
a fiber optic light guide comprising an inlet and an outlet, wherein said inlet is optically coupled to said light source, and
an input locus, wherein said outlet is optically coupled to said input locus.

2. The device of claim 1, wherein said light source comprises a light emitting diode.

3. The device of claim 1, wherein said light source comprises a super bright light emitting diode.

4. The device of claim 1, wherein said input locus comprises a computer key.

5. The device of claim 1, wherein said input locus comprises a translucent computer key.

6. The device of claim 1, wherein said input locus comprises a combination of a translucent portion and an opaque portion.

7. The device of claim 1, additionally comprising a voltage control device electrically coupled to said light source.

8. The device of claim 1, wherein said light source comprises a plurality of individual light sources.

9. A device for illuminating an input device, comprising
a electrical power source,
a light source, wherein said light source is electrically coupled to said electrical power source,
a fiber optic light guide comprising an inlet and an outlet, wherein said inlet is optically coupled to said light source, and
an input locus, wherein said outlet is optically coupled to said input locus.

10. The device of claim 9, wherein said light source comprises a light emitting diode.

11. The device of claim 9, wherein said light source comprises a super bright light emitting diode.

12. The device of claim 9, wherein said input locus comprises a computer key.

13. The device of claim 9, wherein said input locus comprises a translucent computer key.

14. The device of claim 9, wherein said input locus comprises a combination of a translucent portion and an opaque portion.

15. The device of claim 9, additionally comprising a voltage control device electrically coupled to said light source.

16. The device of claim 9, wherein said light source comprises a plurality of individual light sources.

17. A method of illuminating an input device, comprising
illuminating a light source,
directing the light from said light source into the inlet of a light guide, and
directing the light emitted from the outlet of said light guide to illuminate an input locus of the input device.

18. The method of claim 17, additionally comprising the step of providing a control means to selectively control the intensity of the illumination from the light source.
